(19) United States
(12) Patent Application Publication
(10) Pub. No.: US 2026/0177120 A1
(43) Pub. Date: Jun. 25, 2026

(54) CONNECTION BETWEEN HOUSING PARTS, IN PARTICULAR FOR HOUSING PARTS OF ELECTROMECHANICAL BRAKE DEVICES, AND METHOD FOR CONNECTING HOUSINGS

(71) Applicant: Robert Bosch GmbH, Stuttgart (DE)

(72) Inventor: Florian Augenthaler, Immenstadt Im Allgaeu (DE)

(21) Appl. No.: 19/382,327

(22) Filed: Nov. 7, 2025

(30) Foreign Application Priority Data
Nov. 15, 2024 (DE) 10 2024 210 996.7

(51) Int. Cl. F16D 65/16; B60T 13/74

(52) U.S. Cl. CPC F16D 65/16; B60T 13/745; F16D 2250/0084

(57) ABSTRACT

A multipart housing. The multipart housing includes a housing base element and a housing cover element, wherein the housing base element includes an edge against which the housing cover element rests, wherein the housing base element includes wall sections, the inner surfaces of which extend parallel to a joining direction, wherein at least a portion of the surfaces of the wall sections have a structure into which a clamping hook projecting from the housing cover element in the joining direction engages with a clamping surface.

### FIELD

The present invention relates to a multipart housing in which a housing base element and a housing cover element are connected to one another via a clamping hook. The present invention also relates to an electromechanical brake device, in particular for use in a motor vehicle, in which a first housing part and a second housing part, in particular for accommodating a control unit and a drive unit, are connected to one another via a form-locking connection by means of a clamping hook. Lastly, the present invention relates to a method for joining or connecting housing parts of a housing of an electromechanical brake device, in particular for use in a motor vehicle, in which the housing parts are secured to one another via clamping hooks.

### BACKGROUND INFORMATION

A wide variety of types of multipart housings, which are connected or fastened to one another via a connection in a joining direction, are already available in the field of automotive engineering. For instance, different technical solutions and related methods for connecting control units of vehicles or vehicle components with an associated housing or housing part to other housing parts are described. It is described that, in a housing part, for example a housing base element, bores are provided in wall sections with a comparatively high wall thickness and the bores extend in the joining direction. Press pins that project or extend in the joining direction can then be injection-molded into or otherwise fastened to the housing parts to be connected, for example a housing cover element. To connect the housing base element to the housing cover element, the press pins are then pressed into the bore in the joining direction. Such a solution has only a limited holding function, because it does not achieve a form-locking connection but just creates a mere press fit. Such a holding function is accordingly only limitedly suitable for fluctuating temperatures and the associated dimensional changes. Such connections or holding functions are also relatively space-intensive, because the wall sections of the housing base element have to be relatively thick to be able to accommodate or create the bores.

Approaches in which housing parts, in particular also housing parts for accommodating a control unit, are fastened to one another via clamping hooks are described in the related art as well. U.S. Pat. No. 11,858,434B2, for example, discusses hook elements that engage or snap into recesses or openings when the housing parts are moved relative to one another and thus secure or fasten the housing parts to one another.

A similar solution is also described in China utility model CN 203 601 181 U, in which a control unit with an associated holding element or housing part is likewise secured via a connection with clamping hooks.

Japan Patent Application No. JP 2023 007 901 A2 also describes a connection of two housing parts via clamping hooks which engage in recesses or openings in a second housing part starting from one housing part when an end position of a relative movement of the housings relative to one another in a joining direction is or will be reached.

The solutions in the related art have the disadvantage that there is no way to achieve both a secure connection of the housing parts and an abutment of the housing parts to one another in the connected state and at the same time adequately take into account unavoidable manufacturing-related tolerances and inaccuracies of the components involved. The conventional solutions are moreover susceptible to temperature-dependent expansion and contraction phenomena. Lastly, as already stated above, the conventional solutions are often space-intensive.

An object of the present invention is to overcome the disadvantages in the related art and in particular to provide a multipart housing, in particular for an electromechanical brake device, and an associated joining method, which enables a secure connection or fastening of the housing parts and tolerance compensation, in particular in multiple spatial directions, space-saving implementation and robust securing, even in the event of temperature fluctuations.

### SUMMARY

A multipart housing according to the present invention enables a plurality of possible fastening positions of the housing parts relative to one another at least in the joining direction, so that reliable and secure fastening of the housing parts to one another is provided via a form-locking connection independent of the manufacturing-related tolerances of the components involved. At the same time, the multipart housing according to the present invention enables a “benign failure” in the event of fatigue or a defect, which does not lead to a complete loss of function, but maintains a secure connection in the “next best” position.

For this purpose, the multipart housing according to an example embodiment of the present invention comprises a housing part designated as the housing base element and a housing part designated as the housing cover element, wherein the housing base element comprises an edge against which the housing cover element rests, in particular in the fastened or secured state, wherein the housing base element comprises wall sections, the surfaces, in particular the inner surfaces, of which extend parallel to a joining direction, and wherein at least a portion of the surfaces of the wall sections have a structure into which a clamping hook projecting from the housing cover element in the joining direction engages with a clamping surface.

According to an example embodiment of the present invention, the clamping hook is configured as a hook comb comprising a plurality of hook tines, wherein each hook tine forms a, preferably front-side, clamping surface and wherein the clamping surfaces of different hook tines are disposed at at least two different heights in the joining direction and at least one clamping surface of a hook tine forms a form-locking engagement with the structure of the wall sections of the housing base element.

The possibility of tolerance compensation in the joining direction is created via the hook comb with hook tines of varying heights or varying lengths in the joining direction and their clamping surfaces. This is because, depending on the relative position of the housing parts, in particular the housing base element and the housing cover element, in which the two housing parts rest against one another, different hook tines of the hook comb can engage with the structure of the surface, in particular the inner surface of the wall section or the wall sections, which makes it possible to achieve substantially different clamping or locking positions for creating the form-locking connection.

The clamping hook or hook comb can preferably be made of metal, in which case, regardless of the material, the dimensions are advantageously selected such that the hook tines allow a certain amount of elastic deformation as they generate a restoring force. This makes it possible to ensure that the hook tines are slightly elastically deformed initially as the housing parts are joined or connected and then, when an end position or joining position is reached, at least one hook tine is brought into engagement with the structure by a relaxing movement or restoring movement and creates a form-locking connection.

The hook comb or the clamping hook can be overmolded by the housing cover element, for example, or connected to the housing cover element in some other way.

In an advantageous embodiment of the multipart housing of the present invention, it can be provided that the structure is configured as a tooth structure, wherein the teeth extend at a right angle to the joining direction. Such a tooth structure or tooth surface that extends perpendicular to the joining direction can particularly advantageously also achieve tolerance compensation along the extension of the teeth or toothing, because it allows the clamping surfaces of the hook tines to create a form-locking connection at different positions along the tooth structure. Such a tooth structure, in which adjacent teeth are disposed next to one another or behind one another in the joining direction, also makes it possible to achieve even better tolerance compensation in the joining direction, because the clamping surfaces of the hook tines, which are disposed at different heights in the joining direction, can then potentially catch or be brought into engagement with different teeth.

In an advantageous example embodiment of the present invention, a deformable sealing element can be provided on the edge of the housing base element or on the opposite contour of the housing cover element. The sealing element can preferably be configured such that a deformation slightly greater than the grid dimension defined by the different heights of the clamping surfaces and, if applicable, by the distances between the teeth of the tooth structure is possible. This ensures that, in a respective end position in which a clamping surface of a hook tine engages with the structure, in particular with a tooth of the tooth structure, a residual gap between the housing parts is avoided because a deformation of the sealing element compensates for a potential residual gap.

According to an example embodiment of the present invention, it can advantageously be provided that a plurality of hook combs and oppositely disposed structures are provided. For example, it can particularly advantageous be provided that the structures have an extension in two perpendicular spatial directions, which are each substantially perpendicular to the joining direction, because this then enables tolerance compensation in three spatial directions.

In another particularly advantageous embodiment of the present invention, it can be provided that all hook tines have clamping surfaces at different, individual heights in the joining direction. This makes it possible to achieve the maximum number of individual joining or fastening positions of the housing parts. The heights of the clamping surfaces of the hook tines can be equidistant, for instance. Alternatively, it can also be provided that the height distance of the clamping surfaces increases or decreases in the joining direction. It is possible, but not absolutely necessary, that the height of the clamping surfaces of adjacent hook tines increases or decreases steadily.

In particular, according to an example embodiment of the present invention, when the structure of the wall surface comprises a tooth structure with teeth that extend perpendicular to the joining direction, it can preferably be provided that the height difference of the clamping surfaces of the hook tines is not the same as the distance between the teeth of the tooth structure. This particularly advantageously enables a number of end positions in which a respective clamping surface of a hook tine is in form-locking engagement with a corresponding tooth.

As will be described in detail in connection with the method according to the present invention, it can particularly advantageously be provided that the structure, in particular the tooth structure, is configured such that, when the housing parts are moved relative one another in the joining direction, the hook tines of the clamping hook can slide off the structure and, when a force is applied in the direction opposite to the joining direction, the form-locking engagement between a clamping surface of at least one hook tine and the structure, in particular a tooth flank of a tooth of a tooth structure, the form-locking connection is maintained.

In a further particularly advantageous example embodiment of the present invention, it can be provided that the hook tines comprise a curved portion that is shaped such that an end portion of the hook tines that includes the clamping surface is disposed at an acute angle in the joining direction. This advantageously allows the end portion, including the clamping surface, to slide off the structure, in particular with temporary elastic deformation, as long as the hook tines are moved past the structure in the joining direction. The curved portion can advantageously cause the hook tine to be bent more than 90°, preferably more than 110°, relative to the joining direction.

In a further particularly advantageous embodiment of the housing of the present invention, it can be provided that a support structure formed by the housing cover element, in particular a support column which extends with a main extension direction in the joining direction and rests in the joining direction against a section of the hook comb, is provided on a side of the hook comb facing away from the surface of the wall section.

This makes it possible to ensure that the hook comb and thus the hook tines have sufficient support perpendicular to the surface of the wall sections and/or perpendicular to the joining direction, and can therefore produce a sufficiently large elastic restoring force in the event of elastic deformation of the hook tines to ensure that the clamping surface of the hook tines or at least one hook tine and the structure of the surface of the wall section engage and thus create a form-locking connection.

The present invention also includes an electromechanical brake device, in particular for use in a motor vehicle, wherein the brake device comprises an electromechanical drive unit accommodated in a housing, wherein the brake device further comprises a control unit which is likewise accommodated in the housing, wherein the control unit is accommodated at least partly in a first housing part and the drive unit is accommodated at least partly in a second housing part. According to an example embodiment of the present invention, it is provided that the first housing part and the second housing part are respectively configured as a housing base element and as a housing cover element and form a multipart housing according to one of the above-described embodiments. The first housing part can in principle be configured either as a housing base element or as a housing cover element. The same applies to the second housing part. In other words, the configuration between the hook comb and the structured surface of wall sections between the two housing parts can be reversed or interchanged as needed.

This makes it possible to connect the housing parts to one another easily, preferably even without tools, by simply moving them in the joining direction. The hook comb with the hook tines and their clamping surfaces positioned at different heights and the associated structure can be used to achieve a particularly advantageous, finely meshed fastening or engagement of the housing parts with or on one another, to enable particularly good tolerance compensation for unavoidable, manufacturing-related tolerances and inaccuracies and at the same time ensure a reliable, secure and closed-off or sealed fastening of the housing parts.

The present invention also includes a method for joining housing parts of a housing of an electromechanical brake device, in particular for use in a motor vehicle, wherein the brake device comprises an electromechanical drive unit which is accommodated at least partly in a first housing part and also comprises a control unit which is accommodated at least partly in a second housing part, wherein a respective housing part is configured as the housing base element and the housing cover element, wherein the housing base element comprises an edge against which the housing cover element is brought to rest via displacement along a joining direction, wherein the housing base element comprises wall sections, the surfaces, in particular the inner surfaces, of which extend parallel to a joining direction, wherein a portion of the surfaces of the wall sections have a structure into which, during displacement of the housing parts in the joining direction, a clamping hook projecting from the housing cover element in the joining direction is brought into engagement with a clamping surface.

According to an example embodiment of the present invention, it is provided that the clamping hook is configured as a hook comb comprising a plurality of hook tines, wherein each hook tine forms a clamping surface and the clamping surfaces are disposed at at least two different heights in the joining direction so that, when the housing cover element rests against the edge of the housing base element, at least one clamping surface of a hook tine engages in a form-locking manner in the structure.

With respect to the advantages and effects of the method according to the present invention, reference is made to the description above relating to the multipart housing according to the present invention and the electromechanical brake device according to the present invention. In summary it can be said that the configuration of the clamping hook as a hook comb with a plurality of hook tines and clamping surfaces formed by the hook teeth and disposed at different heights in the joining direction makes it possible to ensure tolerance compensation, at least in the joining direction, so that, in order to securely fasten the housing parts to or on one another in different positions of the housing parts, there is always the possibility that at least one hook tine of the hook comb is brought into form-locking engagement with the structure and thus ensure a secure fastening of the housing parts to or on one another, even if the relative arrangement of the housing parts with respect to one another does not result in an absolutely identical end position in each individual process.

According to an advantageous embodiment of the method of the present invention, it can be provided that, when the hook comb moves in the joining direction, the contact surface slides off the structure and, when a force is applied in the direction opposite to the joining direction, at least one contact surface remains in engagement with the structure. This advantageously makes it possible to ensure that, until the housing parts rest against one another and/or against correspondingly interposed, preferably deformable, sealing elements, the relative movement of the housing parts with respect to one another in the joining direction is inhibited but not prevented, whereas, conversely, after reaching a joining end position and the associated creation of a form-locking connection between a contact surface of a hook tine and the structure, movement in the direction opposite to the joining direction is not possible or at least not possible without causing damage.

In an advantageous embodiment of the method of the present invention, it can also be provided that, during the joining or displacement of the housing parts in the joining direction, a tolerance compensation movement in at least one spatial direction that extends substantially perpendicular to the joining direction takes place. This can be achieved, for example, by the structure having an extension perpendicular to the joining direction, so that the hook tines can advantageously be moved or positioned perpendicular to the joining direction relative to the structure, while at the same time retaining the possibility of an engagement or a form-locking connection between the clamping surface of the hook tines and the structure.

Further advantages, features and details of the present invention will emerge from the following description of preferred embodiments of the present invention and with reference to the figures.

Features disclosed above with reference to the method should also be considered disclosed as corresponding device features and vice versa.

### BRIEF DESCRIPTION OF THE DRAWINGS

FIG. 1 shows a perspective, partially transparent illustration of an electromechanical brake device according to the related art.

FIG. 2 shows a section of a multipart housing according to an example embodiment of the present invention.

FIG. 3 shows a front view of a hook comb for use as a hook element in a multipart housing according to an example embodiment of the present invention.

FIG. 4 shows a perspective view of a hook comb, according to an example embodiment of the present invention.

FIG. 5 shows a hook comb in contact with a structure of a wall surface, according to an example embodiment of the present invention.

FIG. 6 shows a modification of the illustration of FIG. 5 with a partially hidden hook comb, according to an example embodiment of the present invention.

### DETAILED DESCRIPTION OF EXAMPLE EMBODIMENTS

The same elements or elements having the same function are provided with the same reference signs in the figures. The present invention is described in the following using an application example of a multipart housing of an electromechanical brake device. However, the present invention is not limited to this housing or application.

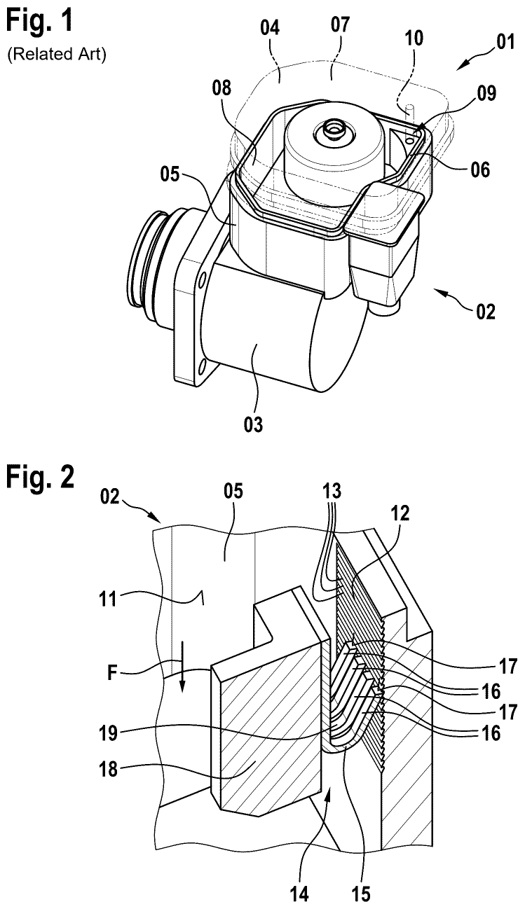

FIG. 1 shows an electromechanical brake device 01 according to the related art. The brake device 01 comprises a housing 02, which consists of multiple housing parts 03, 04. A first housing part 03 comprises a housing base element 05 with an edge 06. The housing part 04 forms a housing cover element 07, which, in the assembled position of the illustration of FIG. 1, rests on the edge 06 of the housing base element 05.

In the example of FIG. 1, the housing base element 05 is configured as an interface housing. The housing cover element 07 is configured as a control unit housing. The housing base element includes wall sections 08 that have an increased wall thickness in certain regions. The region of the increased wall thickness includes bores 09, into which press pins 10 are pressed which are in turn connected to the housing cover element 07. The housing cover element 07 is connected to the housing base element 05 via the press fit of the press pins 10 in the bores 09. This connection is not particularly robust with respect to temperature variations. This connection or the described method of joining the housing parts can moreover only compensate tolerances of the components involved to a very limited extent.

FIG. 2 shows an enlarged section of a multipart housing 02 according to the present invention. It can be seen that an inner surface 11 of the wall section 08 of the housing base element 05 is provided with a structure 12. The structure 12 is embodied as a tooth structure, wherein the individual teeth 13 extend at a right angle to the joining direction F. A clamping hook 14, which is configured as a hook comb 15, projects in the joining direction F from a housing cover element not shown in detail in FIG. 2. The hook comb 15 comprises a plurality of hook tines 16. The hook tines 16 form a, preferably front-side, clamping surface 17, which can be brought into form-locking engagement with the structure 12 of the inner surface 11. The clamping surfaces 17 of the individual hook tines 16 are disposed at different heights in the joining direction F, so that, depending on the relative position of the clamping hooks or the housing cover elements to the housing base element or the structure 12, different hook tines 16 can be brought into form-locking engagement with a flank of a tooth 13.

A support structure 18 formed by the housing cover element, which is not shown, is configured on the side of the clamping hook 14 facing away from the structure 12 or the wall section 08. The support structure 18 can preferably be configured as a support column 19 and have a main extension direction in the joining direction F. The support structure 18 rests against a portion 19 of the clamping hook 15, which extends in the joining direction F. The support structure 18 thus acts as a counter bearing for the clamping hook 15, which ensures that the clamping hook 15 cannot be deformed too easily or too far away from the structure 12 of the wall section 08. In other words, the support structure 18 ensures that the hook tines 16 produce a sufficiently large elastic restoring force when they are elastically deformed by the wall section 08 or the structure 12.

The teeth 13 of the structure 12 are preferably configured such that, when the clamping hook 15 moves in the joining direction F, the hook tines 16 can slide off the structure 12. When a force or moment is applied in the direction opposite to the joining direction F, however, the form-locking connection between the hook tines 16 and the structure 12 of the wall section 08 is maintained or retained by the form-locking engagement of at least one hook tine 16 on a flank of a tooth 13.

FIG. 2 also shows that the extension of the structure 12 and the teeth 13 substantially perpendicular to the joining direction F, enables displaceable positioning of the clamping hook 14 and thus tolerance compensation also substantially perpendicular to the joining direction F. FIG. 2 furthermore shows that the securing according to the present invention of the housing parts ensures “benign failure” if a form-locking connection between the clamping surface 17 and the structure 12 is nonetheless unintentionally released or interrupted. This is because a resulting movement in the direction opposite to the joining direction F merely leads to a minimal loosening movement of the housing parts before a clamping surface 17 of a different hook tine 16 forms a form-locking connection with the structure 12.

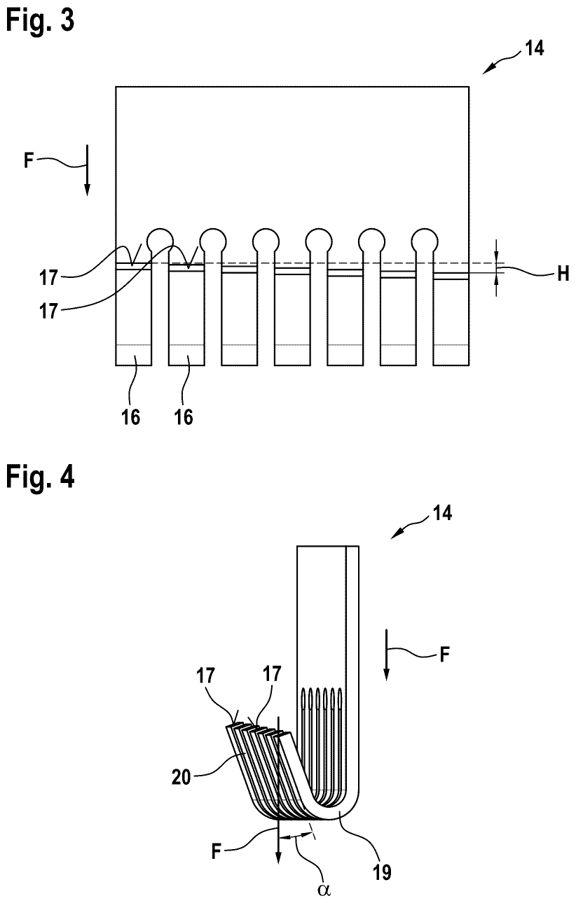

FIG. 3 shows a side view of an advantageous embodiment of a clamping hook 14. The side view again clearly shows that the front-side clamping surfaces 17 of the hook tines 16 have different heights H in the joining direction F. Consequently, depending on the relative position of the housing base element and the housing cover element and the corresponding relative position of the structure 12 to the clamping surfaces 17, different hook tines are available for creating a form-locking engagement.

The different height can also be seen in the perspective view of the clamping hook 14 configured as a hook comb 15 in FIG. 4. The perspective view in FIG. 4 also clearly shows that the clamping hook 15 and also the individual hook tines 16 have a curved portion 19, wherein the curved portion 19 is shaped such that an end portion 20 of the hook tines 16 that includes the clamping surface 17 creates an acute angle a in the joining direction F. This shape of the curved portion 19 also particularly advantageously enables the individual hook tines 16 to slide off the structure of the wall or the wall section 08 when the clamping hook 14 moves in the joining direction F, be brought into a form-locking engagement with the structure after reaching or when reaching an end position and, when a force is applied in the direction opposite to the joining direction while they are engaged, maintain the engagement and thus secure the connection of the housing parts or the housing base element to the housing cover element.

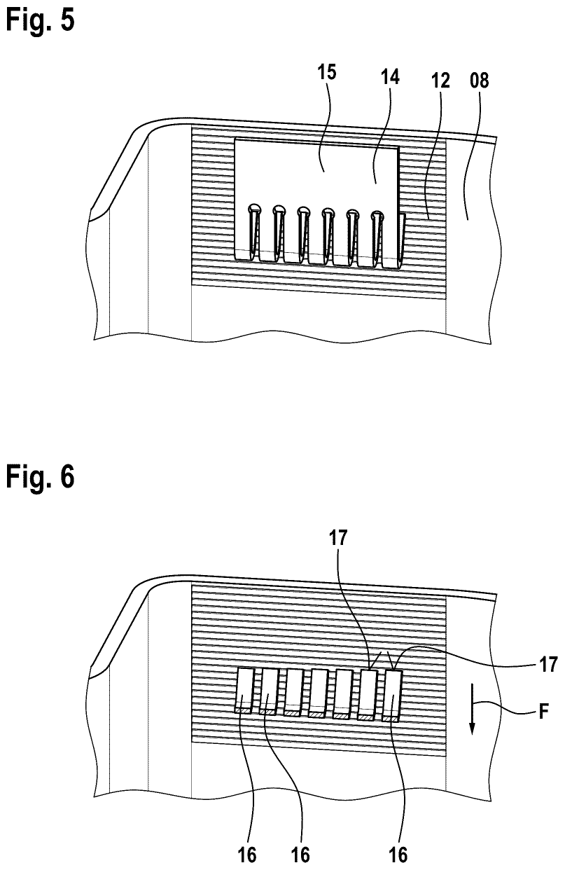

FIG. 5 again shows the clamping hook 14 configured as a hook comb 15 in contact with a structure 12 of a wall section 08 of a housing base element. FIG. 6, in which the clamping hook 14 is partially hidden, again shows the individual hook tines 16. It can be seen that, due to the different extension of the clamping surfaces 17 in the joining direction F, hook tines 16 can potentially engage differently with the respective clamping surface 17 in the structure 12, in particular on tooth flanks, depending on their relative position to one another, and create a form-locking connection there. This also enables tolerance compensation with a very small grid dimension in the joining direction F.

1-9. (canceled)

10. A multipart housing, comprising:
a housing base element; and
a housing cover element;
wherein the housing base element includes an edge against which the housing cover element rests, wherein the housing base element includes wall sections, surfaces of the wall sections extending parallel to a joining direction, wherein at least a portion of the surfaces of the wall sections have a structure into which a clamping hook projecting from the housing cover element in the joining direction engages with a clamping surface; and
wherein the clamping hook is configured as a hook comb including a plurality of hook tines, wherein each hook tine of the plurality of hook tines forms a clamping surface, wherein the clamping surfaces are disposed at at least two different heights in the joining direction and at least one of the clamping surfaces forms a form-locking engagement with the structure.

11. The multipart housing according to claim 10, wherein the structure is configured as a tooth structure, wherein teeth of the tooth structure extend at a right angle to the joining direction.

12. The multipart housing according to claim 10, wherein all of the hook tines have clamping surfaces at respective different, individual heights in the joining direction.

13. The multipart housing according to claim 10, wherein each of the hook tines includes a curved portion which is shaped such that an end portion of each of the hook tines that includes the clamping surface is disposed at an acute angle to the joining direction.

14. The multipart housing according to claim 10, further comprising:
a support structure formed by the housing cover element including a support column which extends with a main extension direction in the joining direction and rests in the joining direction against a section of the hook comb, provided on a side of the hook comb facing away from the surface of the wall section.

15. An electromechanical brake device, comprising:
an electromechanical drive unit accommodated in a housing; and
a control unit which is also accommodated in the housing, wherein the control unit is accommodated at least partly in a first housing part of the housing and the drive unit is accommodated at least partly in a second housing part of the housing;
wherein the first housing part and the second housing part are respectively configured as a housing base element and the housing cover element and form a multipart housing;
wherein the housing base element includes an edge against which the housing cover element rests, wherein the housing base element includes wall sections, surfaces of the wall sections extending parallel to a joining direction, wherein at least a portion of the surfaces of the wall sections have a structure into which a clamping hook projecting from the housing cover element in the joining direction engages with a clamping surface; and
wherein the clamping hook is configured as a hook comb including a plurality of hook tines, wherein each hook tine of the plurality of hook tines forms a clamping surface, wherein the clamping surfaces are disposed at at least two different heights in the joining direction and at least one of the clamping surfaces forms a form-locking engagement with the structure.

16. A method for joining housing parts of a housing of an electromechanical brake device, wherein the brake device includes an electromechanical drive unit which is accommodated at least partly in a first housing part of the housing and also includes a control unit which is accommodated at least partly in a second housing part of the housing, wherein a respective housing part of the first housing part and the second housing part is configured as a housing base element and another respective housing part of the first housing part and the second housing part is configured as a housing cover element, the method comprising:
bringing the housing cover element to rest against an edge of the housing base element via displacement along a joining direction, wherein the housing base element includes wall sections, surfaces of the wall sections extending parallel to a joining direction, wherein at least a portion of the surfaces of the wall sections have a structure into which, during the displacement in the joining direction, a clamping hook projecting from the housing cover element in the joining direction is brought into engagement with a clamping surface;
wherein the clamping hook is configured as a hook comb including a plurality of hook tines, wherein each hook tine of the plurality of hook tines forms a respective clamping surface and the respective clamping surfaces are configured in at least two different heights in the joining direction so that, when the housing cover element rests against the edge of the housing base element, at least one of the respective clamping surfaces engages in a form-locking manner in the structure.

17. The method according to claim 16, wherein when the hook comb moves in the joining direction, the respective clamping surfaces slide off the structure and, when a force is applied in a direction opposite to the joining direction, the at least one of the respective clamping surfaces remains in engagement with the structure.

18. The method according to claim 16, wherein, during the joining, a tolerance compensation movement in at least one spatial direction that extends substantially perpendicular to the joining direction takes place.
